(19) United States
(12) Patent Application Publication
(10) Pub. No.: US 2014/0305415 A1
(43) Pub. Date: Oct. 16, 2014

(54) COMBUSTION CONTROL FOR COMBUSTION ENGINES

(71) Applicant: VOLVO CAR CORPORATION, Goeteborg (SE)

(72) Inventors: Joop Somhorst, Goeteborg (SE); Hakan Persson, Torslanda (SE); Annika Kristoffersson, Hisings Backa (SE)

(73) Assignee: Volvo Car Corporation, Goeteborg (SE)

(21) Appl. No.: 13/862,904

(22) Filed: Apr. 15, 2013

(51) Int. Cl. F02D 41/00; F02D 23/00; F02B 29/04; F02B 37/12

(52) U.S. Cl. CPC F02D 41/0007; F02B 37/12; F02D 23/005; F02B 29/0493; F02D 41/005
USPC 123/563; 123/564; 123/568.21; 123/568.12

(57) ABSTRACT

An arrangement for control of an engine, the arrangement having a super-charger adapted to be disposed between an air intake and an inlet manifold of the engine, the super-charger device being adapted to boost the pressure of the intake air to the engine. The arrangement also has an exhaust gas recirculation, EGR, system, and a super-charger bypass conduit arranged to facilitate a variable bypassing of the super-charger device, the EGR flow level to be controlled such that the effect of the EGR system on the combustion process of the engine can be continuously varied. The arrangement is further adapted to sense a boost pressure level and an inlet temperature level of the inlet air at the inlet manifold of the engine, and to adjust said super-charger bypass and EGR level in order to reach a pre-determined inlet temperature and boost pressure level, thus facilitating control of the combustion process.

### TECHNICAL FIELD

The present disclosure relates to control of the combustion process in a combustion engine.

### BACKGROUND

A key performance indicator of a combustion engine is the efficiency of the engine, i.e., the relationship between the total energy contained in the fuel consumed, and the amount of energy used to perform useful work. The efficiency of an engine is a product of a plurality of factors, e.g., combustion efficiency, thermodynamic efficiency, gas exchange efficiency, and mechanical efficiency.

Classic diesel combustion engines usually have slightly better efficiency than classic spark ignited combustion engines. In order to increase efficiency, the combustion timing can be optimized. Classic diesel engines often have a combustion process which is too slow, thus limiting the efficiency of the engine. However, modern combustion engines based on, e.g., homogeneous charge compression ignition, HCCI, where fuel and oxidizer, usually air, are well mixed in order to speed up the combustion process, have been shown to be limited in efficiency due to a too fast combustion process, resulting in excessive losses due to thermal energy losses.

A combustion strategy which has shown promising results in terms of efficiency is so-called partially premixed combustion, PPC. In PPC, fuel is injected comparably late during the compression phase compared to classic HCCI injection strategies, such that fuel and air are mixed in a controlled manner: the fuel and air mixture should be well mixed, but not too well mixed. PPC combustion is characterized by that a major part of released heat is taking place after end of fuel injection. Thus, a combustion process based on PPC will have a characteristic combustion process in terms of, e.g., released heat as a function of cylinder pressure. PPC has been used successfully with a number of different fuel types, e.g., gasoline, diesel oil, different alcohols, and also mixtures of different fuel types.

PPC has shown outstanding efficiency with low engine-out emissions of soot and NOx. However, to enable PPC-combustion precise control of boost pressure, i.e., the pressure of the oxidizer in the air intake of the engine, and temperature, i.e., the temperature of the oxidizer on the air intake of the engine, is needed. Consequently, one of the biggest challenges for PPC-combustion is in the low load range, i.e., where the engine is operating with low load.

Combustion processes similar in nature to PPC are known in literature under different names and acronyms. Examples of such different names and acronyms are: premixed charge compression ignition, PPCI, partially premixed charge compression ignition, PPCI, and gasoline direct-injection compression ignition, GDCI. The acronym PPC will be used herein to mean the type of combustion process described above, characterized in that a major part of released heat is taking place after end of fuel injection. Consequently, herein, the term PPC should be interpreted in a broad sense, also incorporating similar combustion processes and fuel injection strategies.

In this text, whenever efficiency of an engine is discussed, it is the relationship between the total energy contained in the fuel consumed, and the amount of energy used to perform useful work, in a wide sense, which is referred to. Of particular importance when it comes to efficiency in the current context are combustion efficiency and thermal efficiency

Throughout this text the word air will be used in place of oxidizer when referring to the oxidizer intake of the engine. Thus, throughout the present disclosure, air, when mentioned in relation to the air intake of the engine, should be taken to mean either of oxidizer, air, oxidizer and fuel mixture, e.g., an air/fuel mixture, or exhaust gas mixture, e.g., an intake mixture which is a mix of air and exhaust gas recirculation, EGR, gases, which mixture possibly also comprises fuel.

### SUMMARY

It is an object of the disclosure to obviate at least some of the drawbacks mentioned above and to provide an improved combustion process in a combustion engine.

This object is obtained by an arrangement for combustion control of an engine. The arrangement comprises an air intake in fluid communication with an inlet manifold of the engine, and an exhaust gas outlet in fluid communication with an exhaust manifold of the engine. The arrangement further comprises a super-charger device disposed between the air intake and the inlet manifold of the engine, which super-charger device is adapted to boost the pressure of the intake air to the engine. The arrangement also comprises an exhaust gas recirculation, EGR, system adapted to feed back exhaust gas of the engine to the inlet of the engine.

The arrangement further comprises a super-charger bypass conduit arranged to facilitate a variable bypassing of the super-charger device by means of a first control valve such that the boosting effect of the super-charger can be continuously varied. The EGR flow level is arranged to be controlled by means of a second control valve such that the effect of the EGR system on the combustion process of the engine can be continuously varied. The arrangement further comprises a sensor arrangement adapted to sense a boost pressure level and an inlet temperature level of the inlet air of the engine. The sensor arrangement is connected to a control unit, which control unit is arranged to adjust the first and the second control valve in order to reach a pre-determined, preferred or desired inlet temperature and boost pressure level, respectively, of the inlet air at the inlet manifold of the engine, thus facilitating control of the combustion process.

According to an aspect of the disclosure, the engine implements PPC. When the engine is thus adapted to combust according to the PPC principle outlined above, said pre-determined, preferred or desired inlet temperature and boost pressure level values are set in order to facilitate PPC in the engine.

A known drawback of many engine arrangements comprising super-charger devices is a penalty in fuel efficiency. However, since PPC has shown outstanding efficiency with low engine-out emissions of soot and NOx, a fuel penalty incurred by a supercharger may be overcome and an additional fuel consumption reduction may be attained by the disclosed arrangement. Said additional reduction in fuel consumption is a key benefit of the present disclosure, another being the improved efficiency of the engine.

In other words, by using a supercharger which can be controlled using said first control valve, the boost level of the air intake of the engine can be controlled and continuously varied from a low to a high level of added boost pressure. The inlet temperature of the air intake of the engine can be controlled and continuously varied through the variable EGR-level and also by a variable charge air cooling of the air on the air intake of the engine. The charge air cooling is another feature of some aspects of the disclosure discussed in more detail below.

According to an aspect of the disclosure, the sensor arrangement is further adapted to determine at least one out of an engine speed in terms of revolutions per minute, rpm, an engine load, and a mass air flow, MAF, on the inlet manifold of the engine. The control unit is adapted to adjust at least one out of the first and the second control valve based on information determined by the sensor arrangement in order to reach a pre-determined inlet temperature and boost pressure level of the air intake of the engine.

Thus the control unit makes use of the sensor arrangement in order to adjust at least one of the first and second control valves in order to enable PPC. The pre-determined inlet temperature and boost pressure level mentioned above are suitably determined by means of experimentation using a prototype engine arrangement, or by computer simulation of the combustion process, in order to optimize the combustion process. Also, according to some aspects of the disclosure, said pre-determined inlet temperature and boost pressure level may vary continuously over time as a function of, e.g., engine operating scenario.

According to an aspect, the arrangement for combustion control of an engine also comprises a first and a second charge air cooler, CAC, the first CAC being disposed between the air intake and the super-charger device, the second CAC being disposed between the super-charger device and the inlet manifold of the engine, the flow though the first CAC being arranged to be controlled by means of a third control valve, the flow through the second CAC being arranged to be controlled by means of a fourth control valve. The control unit is adapted to control said inlet temperature of the engine by means of at least one of said third and fourth control valves. Hence, the features of the third and fourth control valves add additional means for controlling temperature of the air of the air intake of the engine.

The present arrangement is thus according to some aspects of the disclosure adapted for charging of the engine using a supercharger with cooling after the supercharger to control the temperature of the inlet mixture of the engine. A key feature of some aspects of the disclosure is the bypass functionality of the supercharger controlled by the first bypass valve, and another key feature is the variable EGR inlet arranged upstream of the engine air intake controlled by the second control valve. These features are suitably used to control both the boost pressure and temperature of the air of the engine air intake. Thus, by means of the disclosed arrangement comprising the first and second control valves, PPC combustion is enabled. Consequently, a benefit of the disclosure is an improved efficiency of the engine achieved by means of PPC, and also a reduced fuel consumption.

According to an aspect, the second CAC is arranged to be bypassed by means of a CAC bypass conduit comprising a fifth control valve, which bypass conduit is in fluid communication with the output of the super-charger device and the inlet manifold of the engine. The state of the fifth control valve determines whether the second CAC is bypassed as opposed to the second CAC being active.

The feature of bypassing the second CAC is especially useful during cold start of the engine, when no additional cooling is required, or when cooling may even have an adverse effect on the performance of the engine. As will be detailed below, in different aspects of the second CAC arrangement the effect of the CAC is adjusted by means other than the bypass arrangement. Examples include aspects where the second CAC is a water cooled CAC, in which case draining the second CAC or stopping circulation of the coolant in the second CAC will have the same effect as bypassing the second CAC.

According to an aspect, the EGR system further comprises an EGR cooler adapted to cool the EGR flow, and an EGR cooler bypass valve facilitating an inactivation, i.e., a bypass, of the EGR cooler. The control unit is adapted to adjust the EGR cooler bypass valve such that the EGR cooler is bypassed during cold start of the engine. Thus, by means of the feature of an EGR cooler with bypass functionality, additional means of temperature control of the air of the air intake of the engine is achieved, thus allowing more degrees of freedom for controlling the combustion process, and consequently allowing for further optimization of the engine combustion process.

According to an aspect, the EGR cooler is arranged to be bypassed during cold start of the engine.

The object stated above is also obtained by a method for combustion control suitable for a partially premixed combustion, PPC, engine. The disclosed method comprises the step of setting a pre-determined, preferred or desired boost pressure level, and setting a pre-determined, preferred or desired inlet temperature. The method also comprises the step of sensing a boost pressure level of the air intake of the PPC engine, and also sensing an inlet temperature of the air intake of the PPC engine. The method also comprises the step of adjusting a bypass level of a supercharger to reach said pre-determined, preferred or desired boost pressure level, as well as the step of adjusting an exhaust gas recirculation, EGR, level to reach said pre-determined, preferred or desired inlet temperature level and dilution level.

According to an aspect, the engine in the method comprises means for partially premixed combustion, PPC, and said pre-determined, preferred or desired inlet temperature and boost pressure level values are set in order to facilitate PPC in the engine.

### BRIEF DESCRIPTION OF THE DRAWINGS

The disclosure will be described in more detail in the following, with reference to the appended drawings, in which

FIG. 1 shows a first layout of an engine with air intake and exhaust system;

FIG. 2 shows a second layout of an engine with air intake and exhaust system;

FIG. 3 shows a third layout of an engine with air intake and exhaust system, and

FIG. 4 shows a flowchart of a method of the disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Embodiments of the present disclosure will be described more fully hereinafter with reference to the accompanying drawings, in which embodiments of the disclosure are shown. The disclosure may, however, be embodied in many different forms and should not be construed as being limited to the embodiments set forth herein. Like numbers in the drawings refer to like elements throughout.

The terminology used herein is for the purpose of describing particular embodiments only, and is not intended to limit the disclosure.

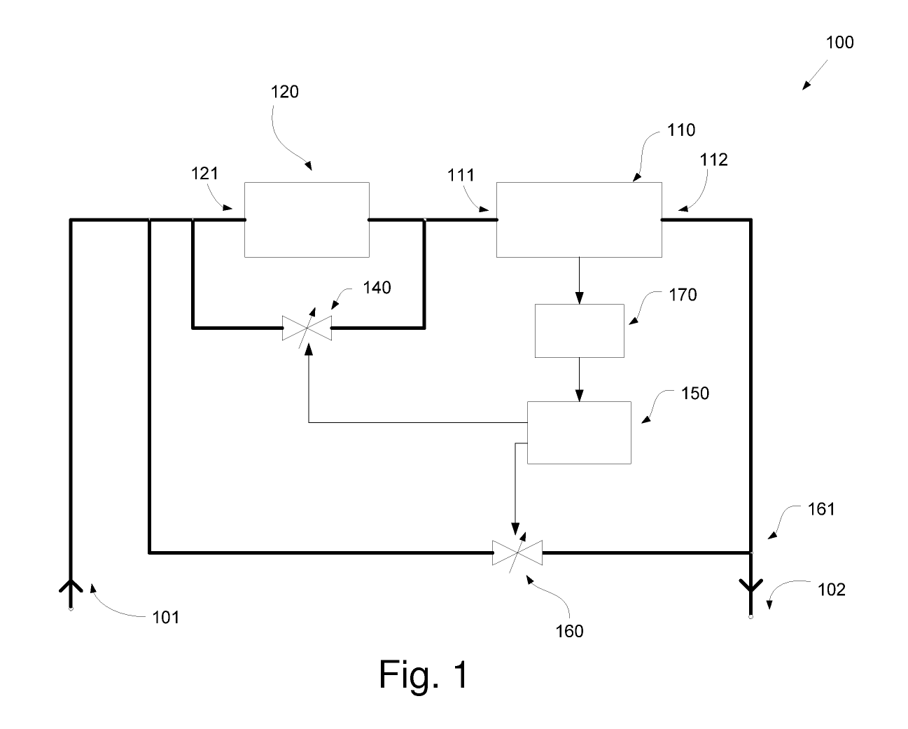

FIG. 1 shows an arrangement 100 for combustion control of an engine 110. The arrangement 100 comprises an air intake 101 in fluid communication with an inlet manifold 111 of the engine 110. The arrangement also comprises an exhaust gas outlet 102 in fluid communication with an exhaust manifold 112 of the engine 110. The arrangement 100 further comprises a super-charger device 120 disposed between the air intake 101 and the inlet manifold 111 of the engine 110. The arrangement 100 also comprises a super-charger bypass conduit arranged to facilitate a variable bypassing of the super-charger device 120 by means of a first control valve 140 such that the boosting effect of the super-charger 120 on the engine can be continuously varied.

The purpose of the super-charger device 120 and variable bypass conduit includes, as mentioned above, boosting the pressure of the intake air to the engine 110 in a controlled manner. Thus, PPC is facilitated, since PPC requires careful control of boost pressure of the air on the air intake of the engine 110. The super-charger device 120 can in embodiments comprise a compressor driven by the engine 110, or by an auxiliary engine, or other energy source. In embodiments, the super-charger device 120 is a Roots super-charger device.

In embodiments where the super-charger device 120 comprises a compressor, the compressor can be arranged to be driven by means of a gearbox arrangement with variable gear ratio. Thus the boost pressure of the super-charger device 120 can be further varied by means of said variable gear ratio.

The arrangement 100 further comprises an exhaust gas recirculation, EGR, system adapted to feed back 161 exhaust gas of the engine 110 to the inlet of the engine 110. The EGR flow level is arranged to be controlled by means of a second control valve 160 such that the effect of the EGR system on the combustion process of the engine 110 can be continuously varied.

The purpose of the EGR system shown in FIG. 1 comprises, as mentioned above, to control the combustion process, and in particular the temperature of the air on the air intake 111 of the engine 110. This temperature control is a key component in enabling PPC in the engine 110. Consequently, by means of the disclosed EGR system, an improved efficiency and a reduced fuel consumption of the engine is obtained.

In FIG. 1 the EGR feedback point is indicated to be upstream of the super-charger device 120, i.e., located between the air intake 101 and the super-charger device 120. However, the present disclosure also encompasses embodiments where this feedback point is situated down-stream from the super-charger device 120, i.e., between the super-charger device 120 and the inlet manifold 111 of the engine 110.

The arrangement 100 shown in FIG. 1 also comprises a sensor arrangement 170 adapted to sense a boost pressure level and an inlet temperature level of the inlet air of the engine 110. The sensor arrangement 170 is connected to a control unit 150, which control unit 150 is arranged to adjust the first 140 and the second 160 control valve in order to reach a pre-determined, preferred or desired inlet temperature and boost pressure level, respectively, of the inlet air at the inlet manifold 111 of the engine 110, thus facilitating control of the combustion process.

The sensor arrangement 170 may be embodied in different ways, including a single multi-function sensor unit, or an array of sensors disposed in connection to the engine 110. Note that the sensor arrangement does not necessarily need to measure pressure and temperature directly on the air on the air intake of the engine 110. Alternative embodiments of the sensor arrangement 170 include sensors and processing units which indirectly infer pressure and temperature of the air on the air intake of the engine 110 from correlated quantities measured in connection to the engine arrangement 100 shown in FIG. 1, e.g., measurements of temperature on the exhaust flow 102 from the engine 110. In embodiments, the sensor arrangement 170 is adapted to sense a boost pressure level and an inlet temperature level of the inlet air at the inlet manifold 111 of the engine 110.

According to some aspects of the disclosure, the engine 110 implements partially premixed combustion, PPC. Consequently, said pre-determined, preferred or desired inlet temperature and boost pressure level values are set in order to facilitate and optimize for PPC in the engine 110. In some combustion engines implementing PPC, the pre-determined, preferred or desired inlet temperature is in the interval 50-250 degrees Celsius, and the pre-determined, preferred or desired boost pressure level is in the interval 0-5 bar absolute pressure. The low ends of the temperature and boost pressure intervals are suitable for use if the fuel permits and when the engine is operating under low load. The high ends of the intervals are suitable for use when the engine is fully loaded. As noted above, many variants of PPC exist, and the combustion strategy is known under a variety of different names and acronyms. Herein, PPC combustion is a type of combustion characterized by that a major part of released heat is taking place after end of fuel injection. Thus, a combustion process based on PPC will have a characteristic combustion process as a function of cylinder pressure. PPC has been used successfully with a number of different fuel types, e.g., gasoline, diesel oil, different alcohols, and also mixtures of different fuel types. A benefit of PPC, and thus also of this disclosure, is an improved efficiency of the combustion process and consequently also an improved efficiency of the engine arrangement 100.

The sensor arrangement 170 is further adapted to determine at least one out of an engine speed in terms of revolutions per minute, rpm, an engine load, and a mass air flow, MAF, on the inlet manifold 111 of the engine 110. The control unit 150 is adapted to adjust at least one out of the first 160 and the second 140 control valve based on information determined by the sensor arrangement 170 in order to reach a pre-determined inlet temperature and boost pressure level of the air intake of the engine 110. Said pre-determined inlet temperature and boost pressure level are suitably determined by means of either computer simulation of the combustion process, or by, means of experimentation using a prototype engine arrangement.

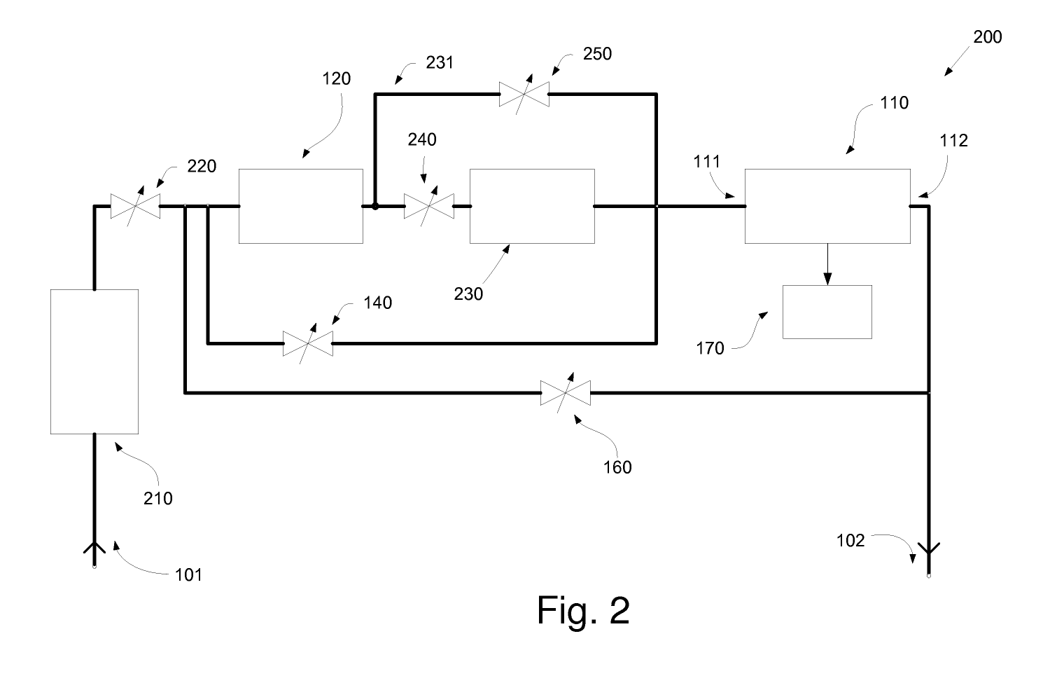

FIG. 2 shows an arrangement 200 which, in addition to the arrangement 100 described in connection with FIG. 1, further comprises a first 210 and a second 230 charge air cooler, CAC. As shown in FIG. 2, the first CAC 210 is disposed between the air intake 101 and the super-charger device 120, while the second CAC is disposed between the super-charger device 120 and the inlet manifold 111 of the engine 110.

The purpose of the first CAC 210 is to cool the intake air coming from the air intake 101 heading towards the air intake manifold 111 of the engine 110. The flow though the first CAC 210 is arranged to be controlled by means of a third control valve 220. This control valve 220 is in some aspects of the arrangement 200 referred to as a throttle valve. According to an aspect, the power outtake of the engine 110 can be controlled by means of this third control valve 220, or throttle valve.

The second CAC 230 is disposed between the super-charger device 120 and the inlet manifold 111 of the engine 110. The flow through the second CAC is arranged to be controlled by means of a fourth control valve 240.

The control unit 150 is adapted to control said inlet temperature of the engine 110 by means of at least one of said third 220 and fourth 240 control valves in a manner which will be further detailed below. Note that control connections between the control unit 150 and control valves are not shown in FIG. 2.

The second CAC 230 is in FIG. 2 arranged to be bypassed by means of a CAC bypass conduit 231 comprising a fifth control valve 250. The bypass conduit 231 is, as shown in FIG. 2, in fluid communication with the output of the super-charger device 120 and the inlet manifold 111 of the engine 110. The state of the fifth control valve 250 determines whether the second CAC 230 is bypassed as opposed to the second CAC 230 being active.

The second CAC 230 suitably comprises a water-cooled charge air cooler, WCAC. However any type of CAC could be used here with preserved technical effect.

The control unit 150 is adapted to adjust the fifth control valve 250 such that the second CAC 240 is bypassed during cold start of the engine 110. This is since no cooling is needed, and could in fact have an adverse effect on efficiency, if the engine and immediate surroundings are too cool, i.e., below ideal temperatures for PPC.

As an alternative to the bypass conduit 231 shown in FIG. 2, a similar technical effect can be achieved without bypass of the WCAC, if instead the coolant of the WCAC is stopped from flowing through the WCAC, i.e., a coolant standstill. Yet another alternative is if the WCAC is drained of coolant when not needed, e.g., during engine cold start.

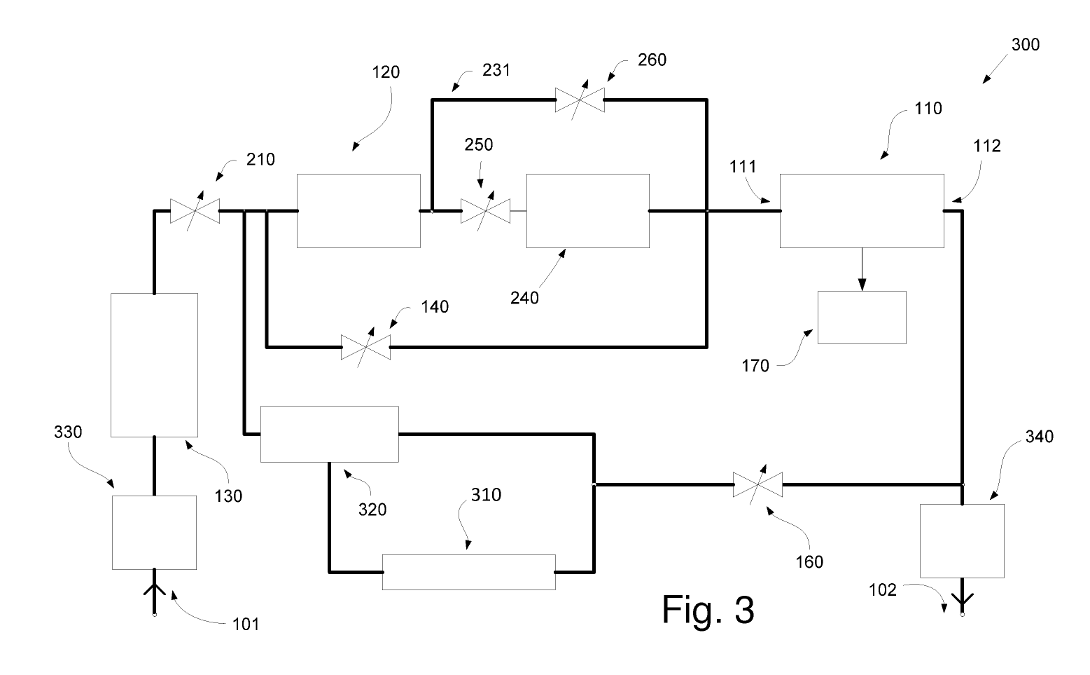

FIG. 3 shows an arrangement 300 where the EGR system comprises an EGR cooler 310 adapted to cool the EGR flow, and an EGR cooler bypass valve 320 which facilitates an inactivation of the EGR cooler 310. The control unit 150 (not shown in FIG. 3) is adapted to adjust the EGR cooler bypass valve 320 such that the EGR cooler 310 is bypassed during, e.g., cold start of the engine 110. Note that control connections between the control unit 150 and control valves are not shown in FIG. 3.

The EGR cooler bypass valve 320 is suitably used for control of the temperature of the intake air of the engine 110 also in other scenarios. Thus, its function and purpose is not to be construed as being limited to cold start conditions only.

The control unit 150 in FIG. 3 is adapted to adjust the first control valve 140 such that the super-charger device 120 is not bypassed and thus fully active at engine speeds below a pre-determined first threshold speed in combination with medium and higher engine loads.

The control unit 150 is also adapted to adjust the first control valve 140 such that the super-charger device 120 is at least partly bypassed and thus not fully active at engine speeds above the pre-determined first threshold speed or when the engine is running at low load.

According to an aspect, and in some engine types, said pre-determined first threshold speed is about 3000 rpm.

FIG. 3 also shows a first filter arrangement 330, suitably comprising at an air filter, located upstream of the first CAC 210. A second filter arrangement 340 is also shown connected to the exhaust conduit. This second filter arrangement 340 suitably comprises either of or a combination of a diesel particle filter, DPF, and a lean NOx trap, LNT, and a selective catalytic reduction, SCR, converter.

A variable nozzle turbine, VNT, sometimes referred to as a turbocharger 350,351, is also shown in FIG. 3 to be part of the arrangement 300. The super-charger device 120 is in FIG. 3 disposed upstream of the turbocharger 351, however, the super-charger device 120 could in some aspects be located downstream of the turbocharger 351. Also, a plurality of super-charger devices 120 and turbocharger devices 350,351 can be used for charging the engine 110. Hence, the present disclosure should not be construed as being limited to only one super-charger device 120 and one turbocharger device 350,351. It should also be noted that the turbo-charger 350,351 is left out in some aspects of the arrangement. Thus, some aspects of the disclosed arrangement do not utilize a turbocharger, and thus solely relies on the super-charger device 120 for charging of the engine 110.

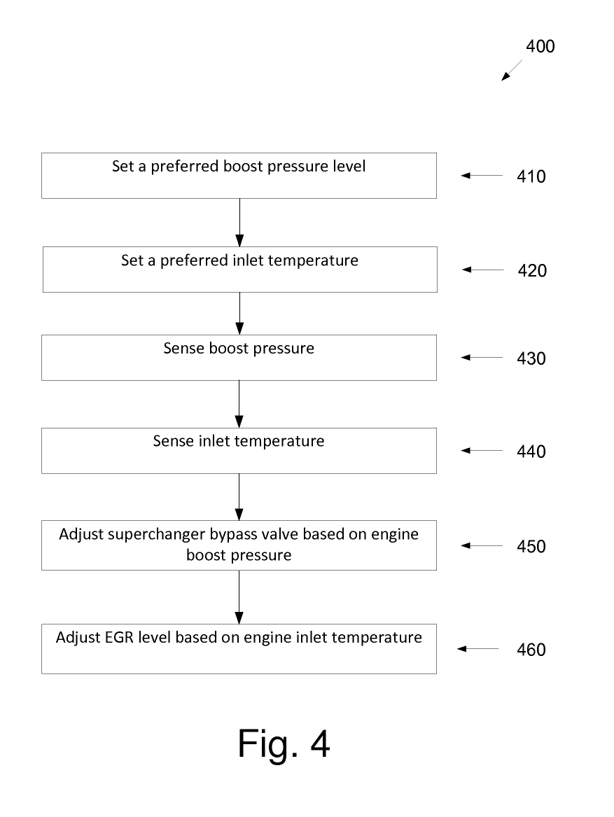

FIG. 4 shows a flowchart describing a method 400 for combustion control suitable for a partially premixed combustion, PPC, engine, the method comprising the steps of setting 410 a pre-determined, preferred or desired boost pressure level, and also setting 420 a pre-determined, preferred or desired inlet temperature. The method 400 also comprises the steps of sensing 430 a boost pressure level of the air intake of the PPC engine, and also sensing 440 an inlet temperature of the air intake of the PPC engine. The method further comprises the step of adjusting 450 a bypass level of a supercharger to reach the pre-determined, preferred or desired boost pressure level, and also adjusting 460 an exhaust gas recirculation, EGR, level to reach the pre-determined, preferred or desired inlet temperature level and dilution level.

In some aspects of the method 400, there is further comprised a step of cooling, by means of a first and a second charge air cooler, CAC, the air intake of the PPC engine. The flow though the first CAC is controlled by means of a third control valve, the flow through the second CAC being is controlled by means of a fourth control valve. The step of cooling also comprises the step of adjusting the inlet temperature of the engine by means of at least one of said third and fourth control valves.

According to an aspect the engine in the above method 400 implements partially premixed combustion, PPC, and said pre-determined, preferred or desired inlet temperature and boost pressure level values are set in order to facilitate PPC in the engine.

According to an aspect the method 400 further comprises the step of determining at least one out of an engine speed in terms of revolutions per minute, rpm, an engine load, and a mass air flow, MAF, on an inlet manifold of the engine. The method 400 also comprises the step of adjusting the bypass level of the supercharger and the EGR level based on information determined by the sensor arrangement in order to reach the pre-determined, preferred or desired inlet temperature and boost pressure level of the air intake of the engine.

According to an aspect the second CAC is arranged to be bypassed by means of a CAC bypass conduit comprising a fifth control valve, the state of the fifth control valve determining whether the second CAC is bypassed as opposed to the second CAC being active. The method 400 further comprises the step of adjusting the fifth control valve such that the second CAC is bypassed during cold start of the engine.

According to an aspect of the method 400 the EGR system further comprises an EGR cooler adapted to cool the EGR flow, and an EGR cooler bypass valve facilitating an inactivation of the EGR cooler. Also the control unit is adapted to adjust the EGR cooler bypass valve such that the EGR cooler is bypassed during cold start of the engine.

According to an aspect, the method 400 can also comprise the step of adjusting the first control valve such that the super-charger device is not bypassed and thus fully active at engine speeds below a pre-determined first threshold speed in combination with medium and higher engine loads.

According to an aspect, the method 400 can further comprise the step of adjusting the first control valve such that the super-charger device is partly bypassed and thus not fully active at engine speeds above a pre-determined first threshold speed or when the engine is running at low load.

The arrangements 100, 200, 300, as well as the disclosed method 400, for combustion control illuminates or abides by certain control principles and operating strategy for facilitating PPC combustion in an optimal way. These control principles will now be further detailed.

Some aspects of the present disclosure are particularly suitable for use with engines operating under part or medium loads, and at speeds above 1000 rpm up to around 4000 rpm.

The different use cases foreseen for the engine 110 include, but are not limited to:
Maximum engine power and engine torque at engine speeds above the pre-determined first threshold speed, i.e., a high speed, full load, and max power use case.
Engine speeds above the pre-determined first threshold speed but only with medium engine load.
Maximum engine torque at speeds below the pre-determined first threshold speed.
Medium engine load at speeds below the pre-determined first threshold speed.
Cold and colder start of the engine, i.e., when the engine is started at a temperature around 20 degrees Celsius, and around −7 degrees Celsius, respectively.
DPF regeneration.

The different drivers for control of the combustion process, or optimality targets, include:
Maximum performance.
Fuel consumption when engine is running at part load.
Transient response engine emissions.
Engine heat-up in different climates.

The control principle and operating strategy are, at least in some embodiments of the disclosure, characterized by:
The inlet temperature of the engine 110 is arranged to be controlled at least in part by means of the EGR system 160, 161, and in aspects of the disclosure also by the first 210 and second 230 CAC. The inlet air boost pressure of the engine 110 is arranged to be controlled at least in part by means of the turbocharger 350, 351, should a turbocharger be present in the arrangement, and by the super-charger device 120.
The sensor arrangement 170 senses when boost pressure or temperature of the air at the air intake of the engine 110 is not at an optimal level, following which the control unit 150 adjusts at least first 140 and second 160 control valves in order to reach optimal boost pressure and inlet temperature.
A first threshold speed, suitable measured in terms of engine rpm, is set based on experimentation with PPC combustion optimality and computer simulation of combustion efficiency.
At engine speeds above the first threshold speed, the super-charger device 120 is bypassed, while, at engine speeds below the first threshold speed the super-charger is active, i.e., not bypassed, except for at the very lowest engine loads when the super-charger is also bypassed. Thus, according to some aspects of the disclosure, the super-charger device 120 is activated at low speeds in combination with medium to high engine load, and bypassed otherwise.
The EGR cooler 310 is bypassed during cold start of the engine 110.
The second CAC 230, which in some embodiments comprises a water-cooled CAC, is bypassed or otherwise inactivated during engine cold start conditions.

In the drawings and specification, there have been disclosed exemplary embodiments of the disclosure. However, many variations and modifications can be made to these embodiments without substantially departing from the principles of the present disclosure. Accordingly, although specific terms are employed, they are used in a generic and descriptive sense only and not for purposes of limitation.

The disclosure is not limited to the examples of embodiments described above and shown in the drawings, but may be freely varied within the scope of the appended claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An arrangement for combustion control of an engine, the arrangement comprising:
an air intake configured to be in fluid communication with an inlet manifold of the engine;
an exhaust gas outlet configured to be in fluid communication with an exhaust manifold of the engine;
a super-charger device configured to be disposed between the air intake and the inlet manifold of the engine, wherein the super-charger device is adapted to boost the pressure of the intake air to the engine;
an exhaust gas recirculation (EGR) system adapted to feed back exhaust gas of the engine to the inlet of the engine;
a super-charger bypass conduit configured for variable bypassing of the super-charger device by a first control valve such that the boosting effect of the super-charger can be continuously variable, wherein an EGR flow level is controllable by a second control valve such that the effect of the EGR system on the combustion process of the engine is continuously variable; and
a sensor arrangement adapted to sense a boost pressure level and an inlet temperature level of the inlet air of the engine, the sensor arrangement adapted to be connected to a control unit, wherein the control unit is configured to adjust the first and the second control valve in order to reach a pre-determined inlet temperature and boost pressure level, respectively, of the inlet air at the inlet manifold of the engine to facilitate control of the combustion process.

2. The arrangement of claim 1, wherein the engine comprises means for partially premixed combustion, PPC, and wherein said pre-determined inlet temperature and boost pressure level values are set in order to facilitate PPC in the engine.

3. The arrangement of claim 1, wherein the sensor arrangement is further adapted to determine at least one out of an engine speed in terms of revolutions per minute, rpm, an engine load, and a mass air flow, MAF, on the inlet manifold of the engine, the control unit further being adapted to adjust at least one out of the first and the second control valve based on information determined by the sensor arrangement in order to reach a pre-determined inlet temperature and boost pressure level of the air intake of the engine.

4. The arrangement of claim 1, further comprising a first (and a second charge air cooler (CAC) the first CAC being disposed between the air intake and the super-charger device, the second CAC being disposed between the super-charger device (120) and the inlet manifold of the engine, the flow though the first CAC being arranged to be controlled by a third control valve, the flow through the second CAC being arranged to be controlled by a fourth control valve, the control unit further being adapted to control said inlet temperature of the engine at least one of said third and fourth control valves.

5. The arrangement of claim 4, wherein the second CAC is arranged to be bypassed by a CAC bypass conduit comprising a fifth control valve, which bypass conduit is in fluid communication with the output of the super-charger device and the inlet manifold of the engine, the state of the fifth control valve determining whether the second CAC is bypassed as opposed to the second CAC being active.

6. The arrangement of claim 5, wherein the second CAC comprises a water-cooled charge air cooler (WCAC).

7. The arrangement of claim 5, wherein the control unit is adapted to adjust the fifth control valve such that the second CAC is bypassed during cold start of the engine.

8. The arrangement of claim 1, wherein the EGR system further comprises an EGR cooler adapted to cool the EGR flow, and an EGR cooler bypass valve (320) facilitating an inactivation of the EGR cooler, the control unit being adapted to adjust the EGR cooler bypass valve such that the EGR cooler is bypassed during cold start of the engine.

9. The arrangement of claim 1, wherein the control unit is adapted to adjust the first control valve such that the super-charger device is not bypassed and thus fully active at engine speeds below a pre-determined first threshold speed in combination with medium and higher engine loads.

10. The arrangement of claim 1, wherein the control unit is adapted to adjust the first control valve such that the super-charger device is partly bypassed and thus not fully active at engine speeds above the pre-determined first threshold speed or when the engine is running at low load.

11. A method for combustion control suitable for a partially premixed combustion (PPC) engine, the method comprising:
setting a pre-determined boost pressure level;
setting a pre-determined inlet temperature;
sensing a boost pressure level of an air intake of the PPC engine;
sensing an inlet temperature of the air intake of the PPC engine;
adjusting a bypass level of a supercharger to reach the pre-determined boost pressure level; and
adjusting an exhaust gas recirculation (EGR) level to reach the pre-determined inlet temperature level and a dilution level.

12. The method of claim 11, wherein the engine implements partially premixed combustion, (PPC) and wherein said pre-determined or inlet temperature and boost pressure level values are set in order to facilitate PPC in the engine.

13. The method of claim 11, further comprising determining at least one out of an engine speed in terms of revolutions per minute, rpm, an engine load, and a mass air flow, MAF, on an inlet manifold of the engine, the method further comprising adjusting the bypass level of the supercharger and the EGR level based on information determined by the sensor arrangement in order to reach the pre-determined or inlet temperature and boost pressure level of the air intake of the engine.

14. The method of claim 11, further comprising cooling, by a first and a second charge air cooler, CAC, the air intake of the PPC engine, the flow though the first CAC being arranged to be controlled by a third control valve, the flow through the second CAC being arranged to be controlled a fourth control valve, the step of cooling further comprising adjusting the inlet temperature of the engine by at least one of said third and fourth control valves.

15. The method of claim 14, wherein the second CAC is arranged to be bypassed by a CAC bypass conduit comprising a fifth control valve, the state of the fifth control valve determining whether the second CAC is bypassed as opposed to the second CAC being active, the method further comprising adjusting the fifth control valve such that the second CAC is bypassed during cold start of the engine.

16. The method of claim 15, wherein the second CAC comprises a water-cooled charge air cooler (WCAC).

17. The arrangement of claim 11, wherein the EGR system further comprises an EGR cooler adapted to cool the EGR flow, and an EGR cooler bypass valve facilitating an inactivation of the EGR cooler, the control unit being adapted to adjust the EGR cooler bypass valve such that the EGR cooler is bypassed during cold start of the engine.

18. The method of claim 11, further comprising adjusting the first control valve such that the super-charger device is not bypassed and thus fully active at engine speeds below a pre-determined first threshold speed in combination with medium and higher engine loads.

19. The method of claim 11, further comprising adjusting the first control valve such that the super-charger device is partly bypassed and thus not fully active at engine speeds above a pre-determined first threshold speed or when the engine is running at low load.

20. In an arrangement for combustion control of an engine, the arrangement comprising an air intake configured to be in fluid communication with an inlet manifold of the engine, an exhaust gas outlet configured to be in fluid communication with an exhaust manifold of the engine, a super-charger device configured to be disposed between the air intake and the inlet manifold of the engine, wherein the super-charger device is adapted to boost the pressure of the intake air to the engine, and an exhaust gas recirculation (EGR) system adapted to feed back exhaust gas of the engine to the inlet of the engine, a sub-arrangement comprising:
a first control valve;
a second control valve;
a control unit;
a super-charger bypass conduit configured for variable bypassing of the super-charger device by the first control valve such that the boosting effect of the super-charger can be continuously variable, wherein the second control valve is configured to control an EGR flow level such that the effect of the EGR system on the combustion process of the engine can be continuously variable; and
a sensor arrangement adapted to sense a boost pressure level and an inlet temperature level of the inlet air of the engine, the sensor arrangement adapted to be connected to the control unit, wherein the control unit is configured to adjust the first and the second control valve in order to reach a pre-determined inlet temperature and boost pressure level, respectively, of the inlet air at the inlet manifold of the engine to facilitate control of the combustion process.
